(19) United States
(12) Patent Application Publication
(10) Pub. No.: US 2010/0020022 A1
(43) Pub. Date: Jan. 28, 2010

(54) Visual Feedback System For Touch Input Devices

(75) Inventors: Deborah C. Russell, Austin, TX (US); Roy W. Stedman, Austin, TX (US); Keith Allen Kozak, Round Rock, TX (US)

Correspondence Address: HAYNES AND BOONE, LLP;IP Section, 2323 Victory Avenue, Suite 700, Dallas, TX, 75219, US

(73) Assignee: Dell Products L.P., Round Rock, TX (US)

(21) Appl. No.: 12/179,325

(22) Filed: Jul. 24, 2008

(51) Int. Cl. G06F 3/041

(52) U.S. Cl. 345/173

(57) ABSTRACT

A visual feedback system includes a touch input screen. A proximity sensing device is coupled to the touch input screen and operable to determine a position of an input member relative to the touch input screen when the input member is proximate to the touch input screen but prior to the contact of the input member and the touch input screen. A visual feedback engine is coupled to the touch input screen and the proximity sensing device and is operable to receive the position of the input member from the proximity sensing device and provide a visual feedback for data displayed on the touch input screen that corresponds to the position of the input member relative to the touch input screen.

### BACKGROUND

The present disclosure relates generally to information handling systems, and more particularly to a visual feedback system for a touch input device.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Many IHSs are transitioning from traditional input devices such as, for example, keyboards, mice, and/or a variety of other conventional input devices known in the art, to touch input devices (e.g., touch screen displays) that allow an IHS user to manipulate data that is displayed on a screen by touching the screen with their fingers or other input members in order to “interact” with the data in a variety of ways. The interaction with data using touch inputs raises a number of issues.

For example, one problem that arises with interacting with data by providing touch inputs may occur when that data being displayed is small relative to the users finger/input member and/or when the data is closely grouped together. This problem may occur more often with smaller touch input devices such as, for example, portable IHSs, but may exist for any touch input device when used to display small and/or closely grouped data. When a user of the touch input device wants to select data by providing a touch input, these issues may result in a difficulty for the user in determining whether the right piece of data is going to be selected by a particular touch input. Such problems may even result in the user selecting the wrong data, which requires the user to return from the incorrect selection to repeat the process in an attempt to select the desired data, increasing the time necessary to navigate through data and providing a generally poor user experience.

Accordingly, it would be desirable to provide visual feedback for a touch input device to remedy the issues discussed above.

### SUMMARY

According to one embodiment, a visual feedback system includes a touch input screen, a proximity sensing device that is coupled to the touch input screen, the proximity sensing device operable to determine a position of an input member relative to the touch input screen when the input member is proximate to the touch input screen but prior to the contact of the input member and the touch input screen; and a visual feedback engine that is coupled to the touch input screen and the proximity sensing device, the visual feedback engine operable to receive the position of the input member from the proximity sensing device and provide a visual feedback for data displayed on the touch input screen that corresponds to the position of the input member relative to the touch input screen.

### BRIEF DESCRIPTION OF THE DRAWINGS

FIG. 1 is a schematic view illustrating an embodiment of an IHS.

FIG. 2 is a schematic view illustrating an embodiment of a visual feedback system.

FIG. 3a is a perspective view illustrating an embodiment of a display used with the visual feedback system of FIG. 2.

FIG. 3b is a cross sectional view illustrating an embodiment of the display of FIG. 3a.

FIG. 4a is a perspective view illustrating an embodiment of a display used with the visual feedback system of FIG. 2.

FIG. 4b is a cross sectional view illustrating an embodiment of the display of FIG. 4a.

FIG. 5a is a flow chart illustrating an embodiment of a method for providing visual feedback.

FIG. 5b is a cross sectional view of an input member being positioned proximate the display of FIGS. 3a and 3b.

FIG. 5c is a cross sectional view of an input member being positioned proximate the display of FIGS. 4a and 4b.

FIG. 5d is a partial front view of data being displayed on a touch input screen.

FIG. 5e is a partial front view of a visual feedback being provided for the data of FIG. 5d.

FIG. 5f is a partial front view of data being displayed on a touch input screen.

FIG. 5g is a partial front view of a visual feedback being provided for the data of FIG. 5f.

FIG. 5h is a partial front view of data being displayed on a touch input screen.

FIG. 5i is a partial front view of a visual feedback being provided for the data of FIG. 5h.

FIG. 5j is a partial front view of a visual feedback being provided for the data of FIG. 5f.

FIG. 5k is a partial front view of a visual feedback being provided for the data of FIG. 5f.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

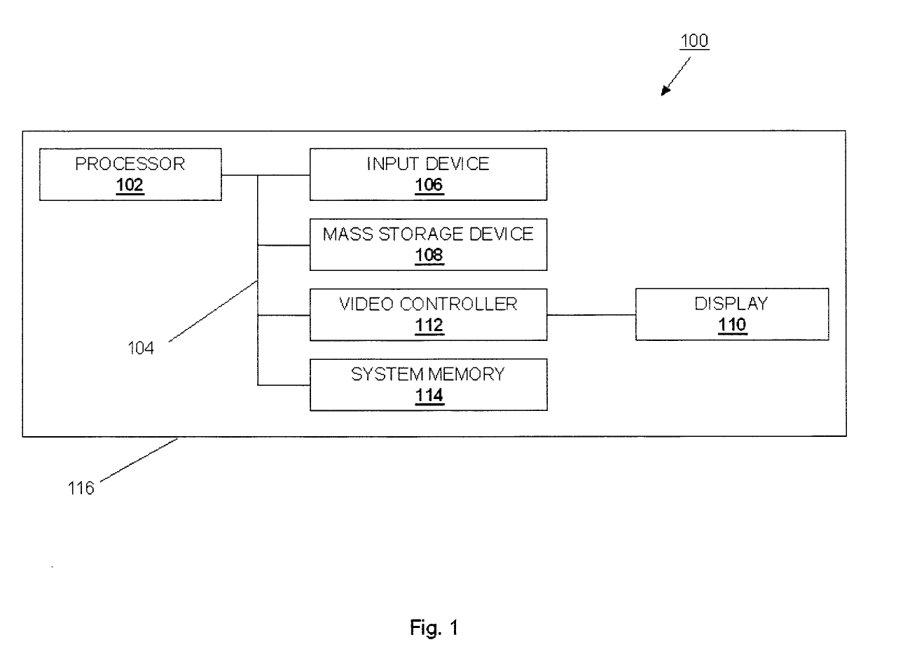

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

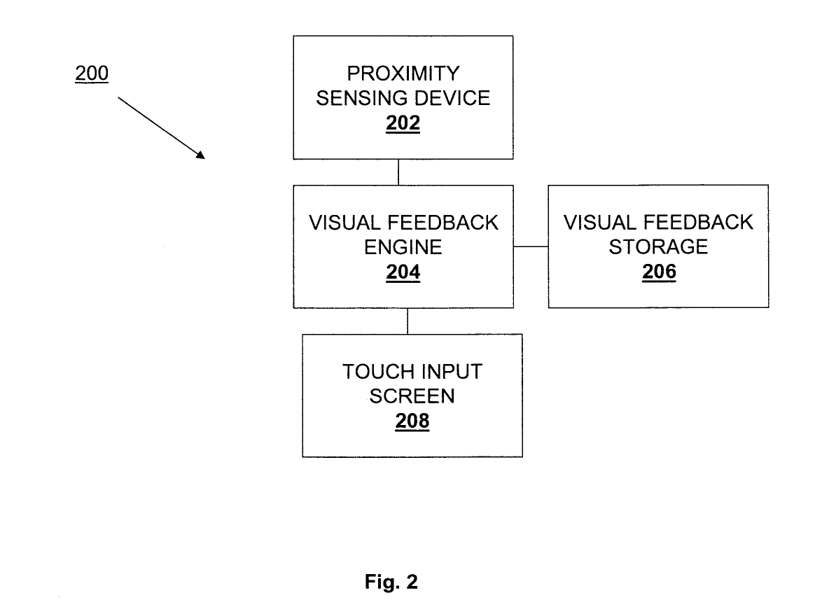

Referring now to FIG. 2, an embodiment of a visual feedback system 200 is illustrated. In an embodiment, the visual feedback system 200 may be included in the IHS 100, described above with reference to FIG. 1. The visual feedback system 200 includes a proximity sensing device 202 that is described in further detail below. The proximity sensing device 202 is coupled to a visual feedback engine 204. In an embodiment, the visual feedback engine 204 may include computer executable instructions (e.g., firmware, software, etc.) located on a computer-readable medium that is included in an IHS such as, for example, the IHS 100, described above with reference to FIG. 1. A visual feedback storage 206 is coupled to the visual feedback engine 204. In an embodiment, the visual feedback storage 206 may be the mass storage 108, the system memory 112, and/or a variety of other storage media known in the art. In an embodiment, the visual feedback storage 206 includes a plurality of visual feedback actions that may include associations with display data (described in further detail below) the associations which may be made by, for example, an IHS user, an IHS manufacturer, a data provider, and/or a variety of other entities known in the art. A touch input screen 208 is also coupled to the visual feedback engine 204. In an embodiment, the touch input screen 208 may be part of the display 110, described above with reference to FIG. 1.

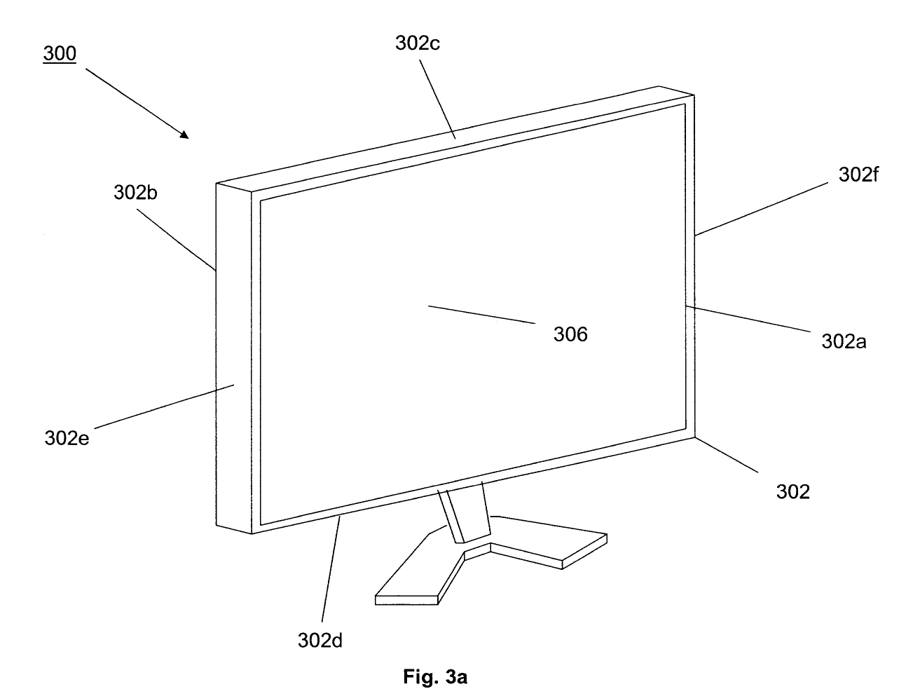

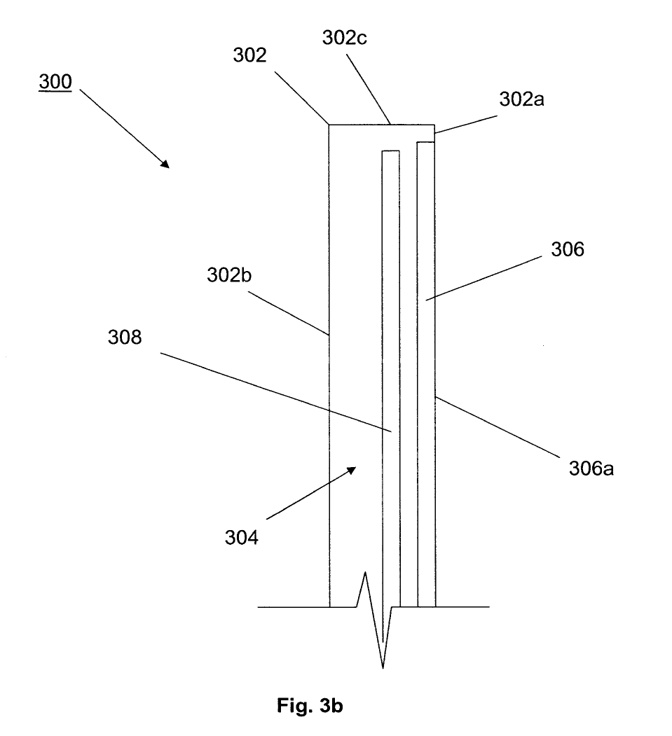

Referring now to FIGS. 3a and 3b, an embodiment of a display 300 is illustrated. While the display 300 is illustrated as a ‘stand-alone’ display for use with, for example, a desktop computer, the present disclosure is not so limited. One of skill in the art will recognize that the teachings described with reference to FIGS. 3a and 3b are applicable to a variety of other touch input devices such as, example, portable/notebook computers, phones, televisions, and/or a variety of other devices known in the art that utilize touch inputs. In an embodiment, the display 300 may be, for example, the display 110, described above with reference to FIG. 1. The display 300 includes a display chassis 302 having a front surface 302a, a rear surface 302b located opposite the front surface 302a, a top surface 302c extending between the front surface 302a and the rear surface 302b, a bottom surface 302d located opposite the top surface 302c and extending between the front surface 302a and the rear surface 302b, and a pair of opposing sides surfaces 302e and 302f extending between the front surface 302a, the rear surface 302b, the top surface 302b, and the bottom surface 302d. A housing 304 is defined by the display chassis 302 between the front surface 302a, the rear surface 302b, the top surface 302c, the bottom surface 302d, and the side surfaces 302e and 302f. A touch input screen 306 is coupled to the display chassis 302 and is partially housed in the housing 304 and located adjacent the front surface 302a. In an embodiment, the touch input screen 306 may be the touch input screen 208, described above with reference to FIG. 2. In the illustrated embodiment, a proximity sensing device 308 is housed in the housing 304 defined by the display chassis 302 and located adjacent the touch input screen 306. In an embodiment, the proximity sensing device 308 is part of the touch input screen 306. The proximity sensing device 308 is operable to determine the position of objects that are located proximate the touch input screen 306 by performing methods known in the art to detect those objects through at least a front surface 306a of the touch input screen 306. In an embodiment, the proximity sensing device 308 may be the proximity sensing device 202, described above with reference to FIG. 2.

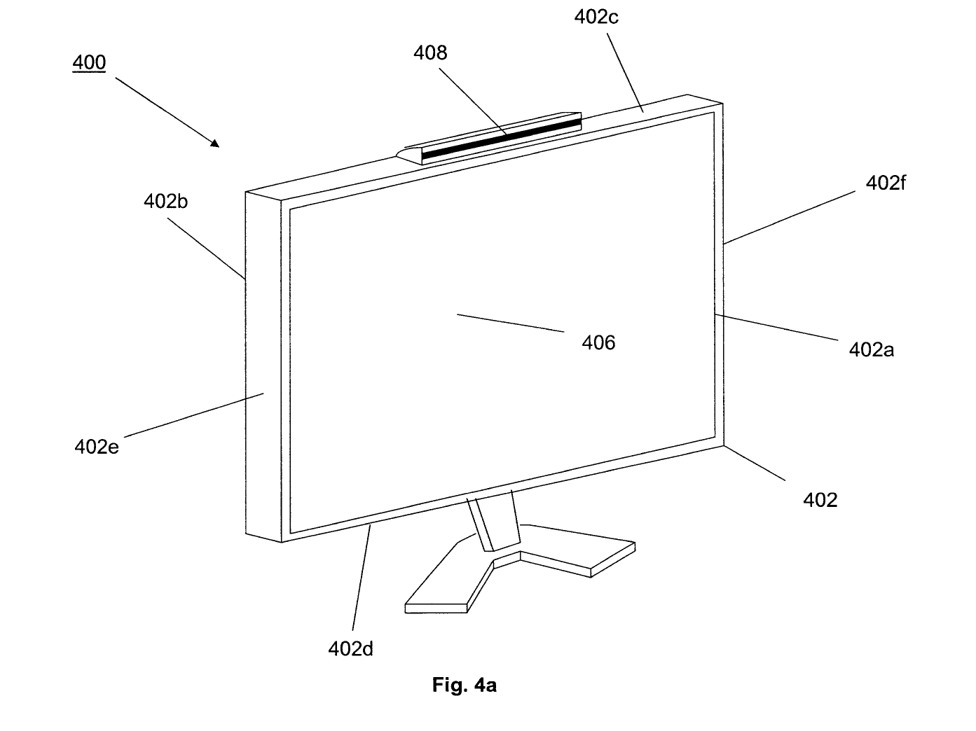

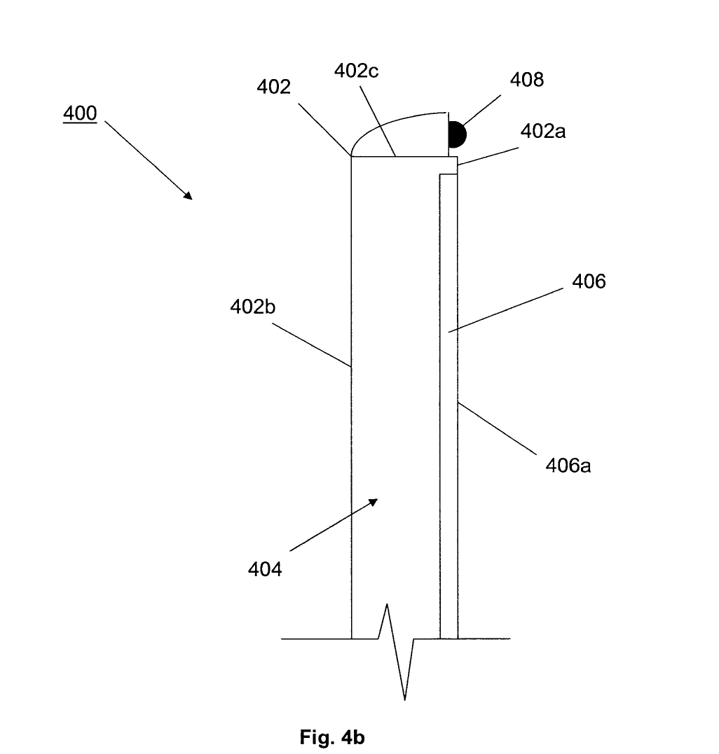

Referring now to FIGS. 4a and 4b, an embodiment of a display 400 is illustrated. While the display 400 is illustrated as a ‘stand-alone’ display for use with, for example, a desktop computer, the present disclosure is not so limited. One of skill in the art will recognize that the teachings described with reference to FIGS. 4a and 4b are applicable to a variety of other touch input devices such as, example, portable/notebook computers, phones, televisions, and/or a variety of other devices known in the art that utilize touch inputs. In an embodiment, the display 400 may be, for example, the display 110, described above with reference to FIG. 1. The display 400 includes a display chassis 402 having a front surface 402a, a rear surface 402b located opposite the front surface 402a, a top surface 402c extending between the front surface 402a and the rear surface 402b, a bottom surface 402d located opposite the top surface 402c and extending between the front surface 402a and the rear surface 402b, and a pair of opposing sides surfaces 402e and 402f extending between the front surface 402a, the rear surface 402b, the top surface 402b, and the bottom surface 402d. A housing 404 is defined by the display chassis 402 between the front surface 402a, the rear surface 402b, the top surface 402c, the bottom surface 402d, and the side surfaces 402e and 402f. A touch input screen 406 is coupled to the display chassis 402 and is partially housed in the housing 404 and located adjacent the front surface 402a. In an embodiment, the touch input screen 406 may be the touch input screen 208, described above with reference to FIG. 2. In the illustrated embodiment, a proximity sensing device 408 is coupled to the top surface 402c the display chassis 402. In an embodiment, additional proximity sensing devices may be coupled to other surfaces of the display chassis 402 and adjacent the touch input screen 406. In an embodiment, the proximity sensing device 408 includes at least a portion that extends past the front surface 402a of the display chassis 402 to, for example, give the proximity sensing device 408 a ‘line of sight’ that includes the area immediately adjacent the front surface 406a of the touch input screen 406. The proximity sensing device 408 is operable to determine the position of objects that are positioned proximate the touch input screen 406 by performing methods known in the art adjacent the front surface 406a of the touch input screen 306 (e.g., using infrared sensing technology to detect objects.) In an embodiment, the proximity sensing device 408 may be the proximity sensing device 202, described above with reference to FIG. 2.

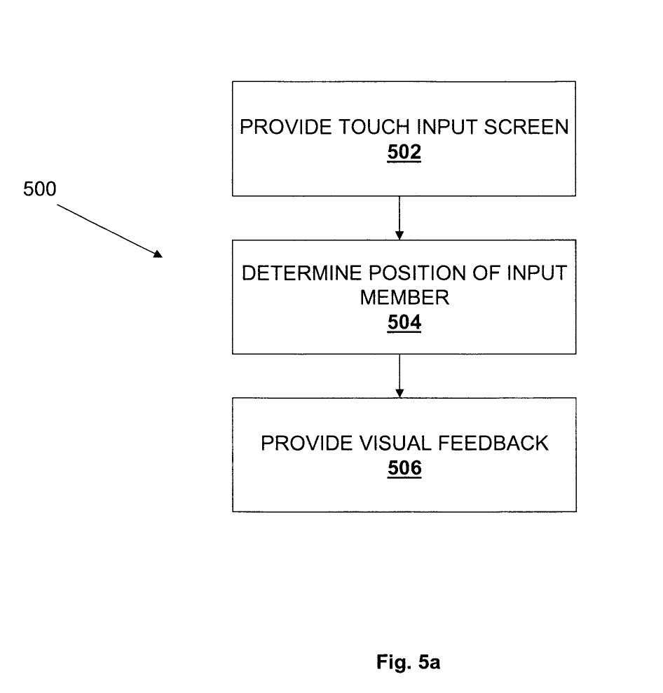

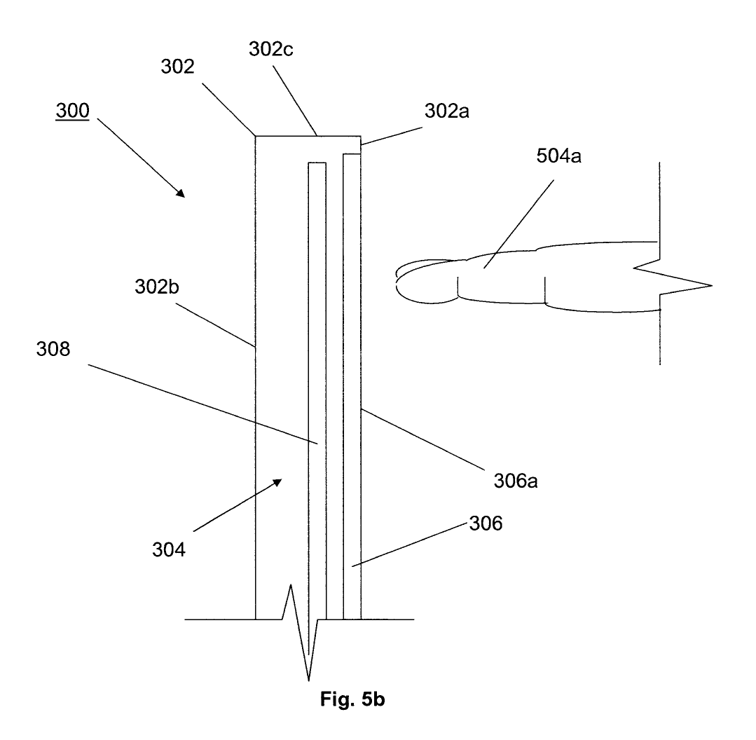

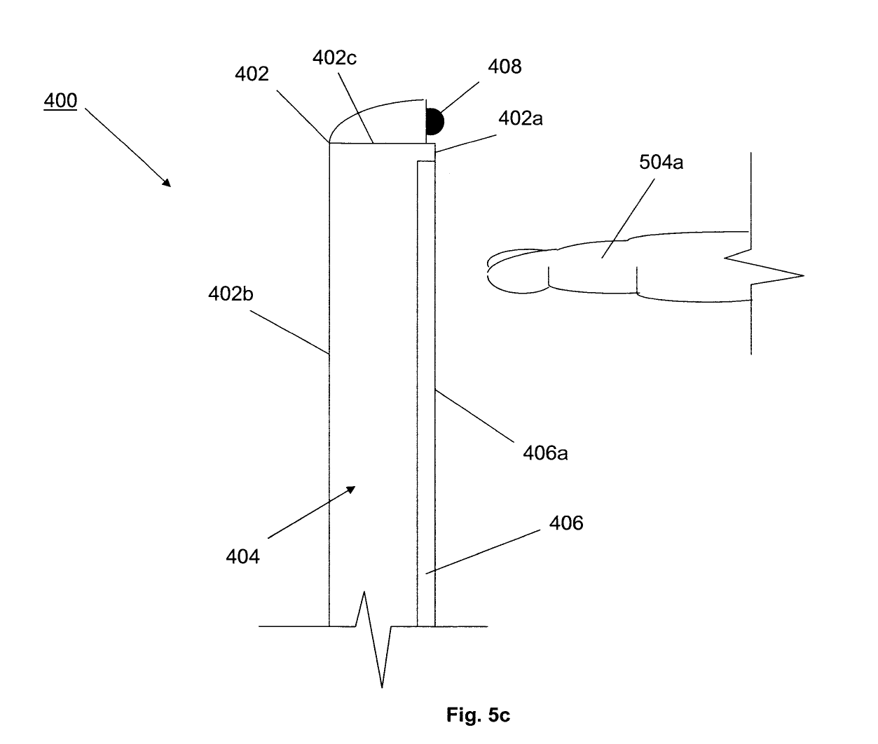

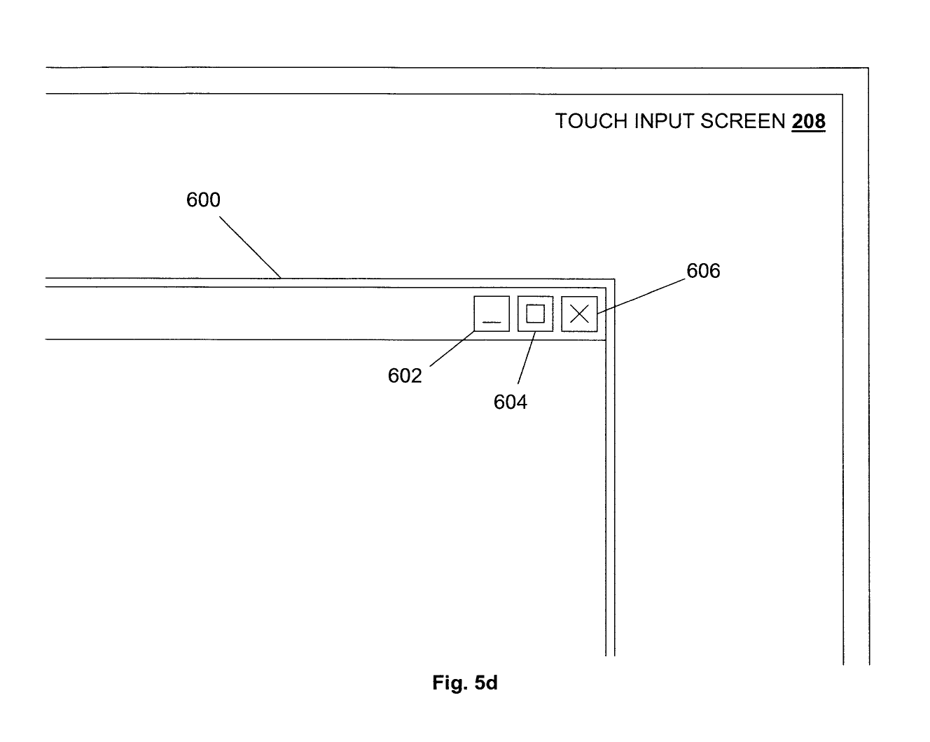

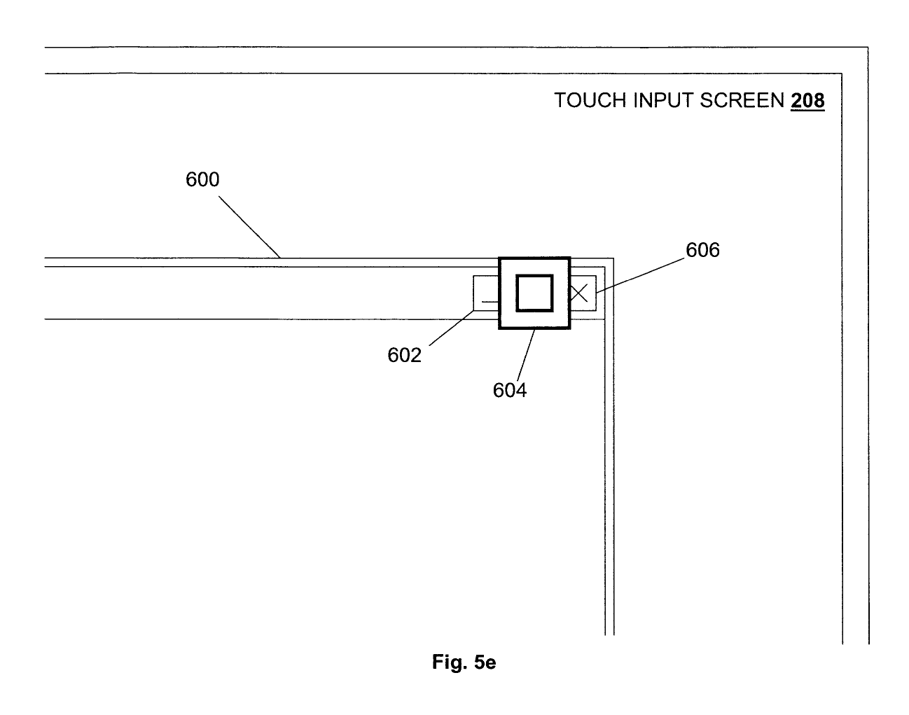

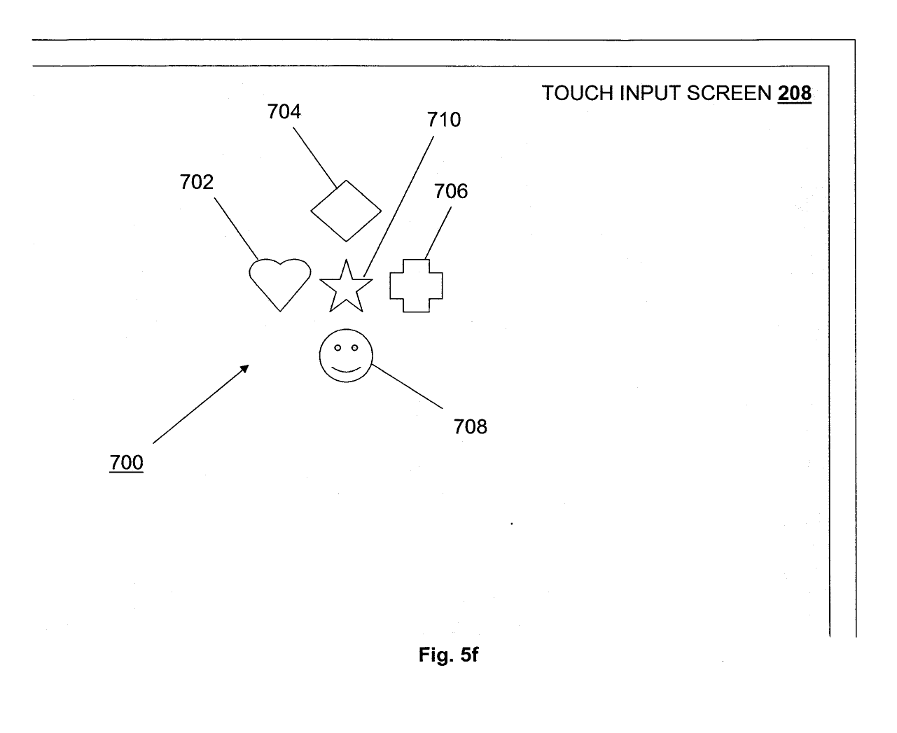

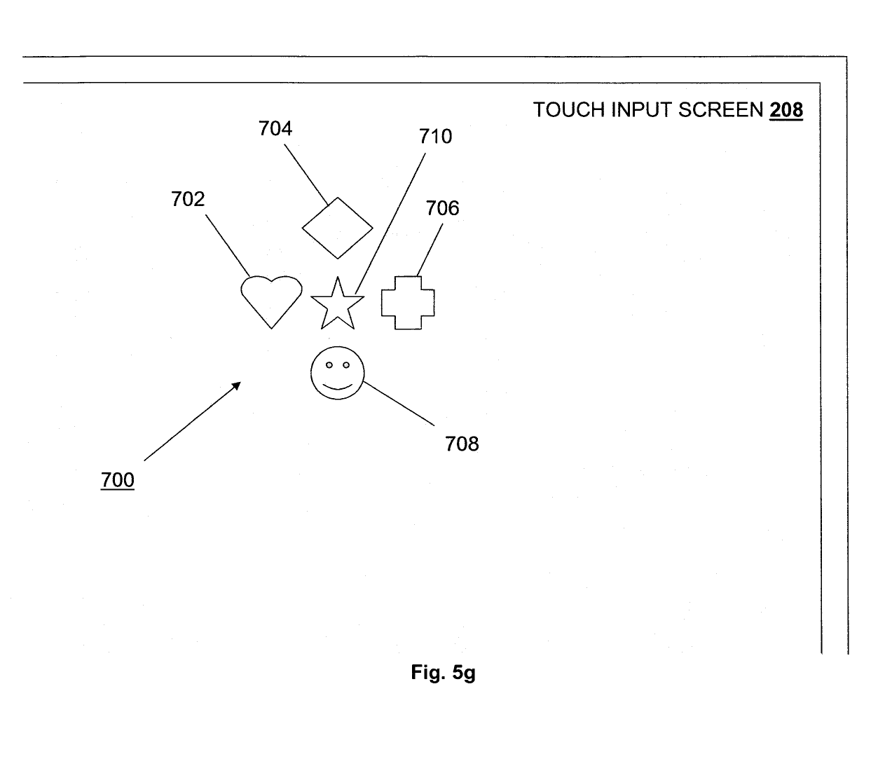

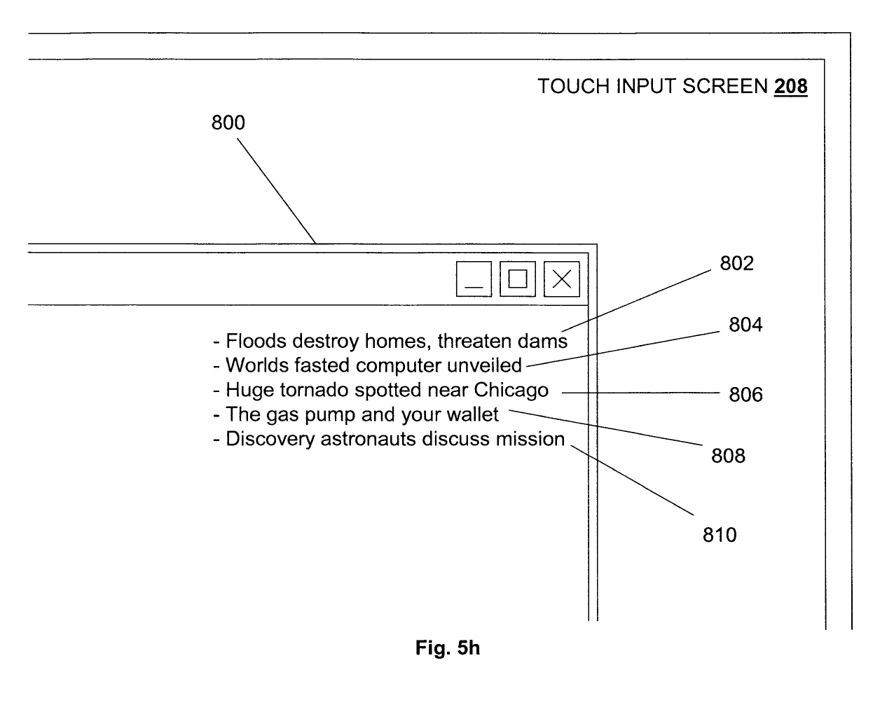

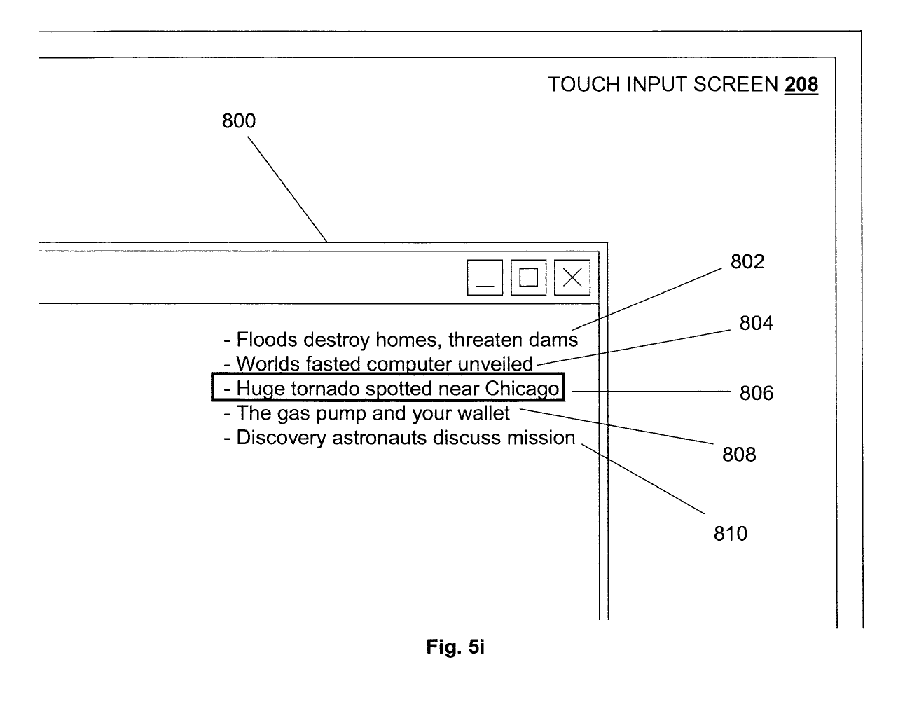

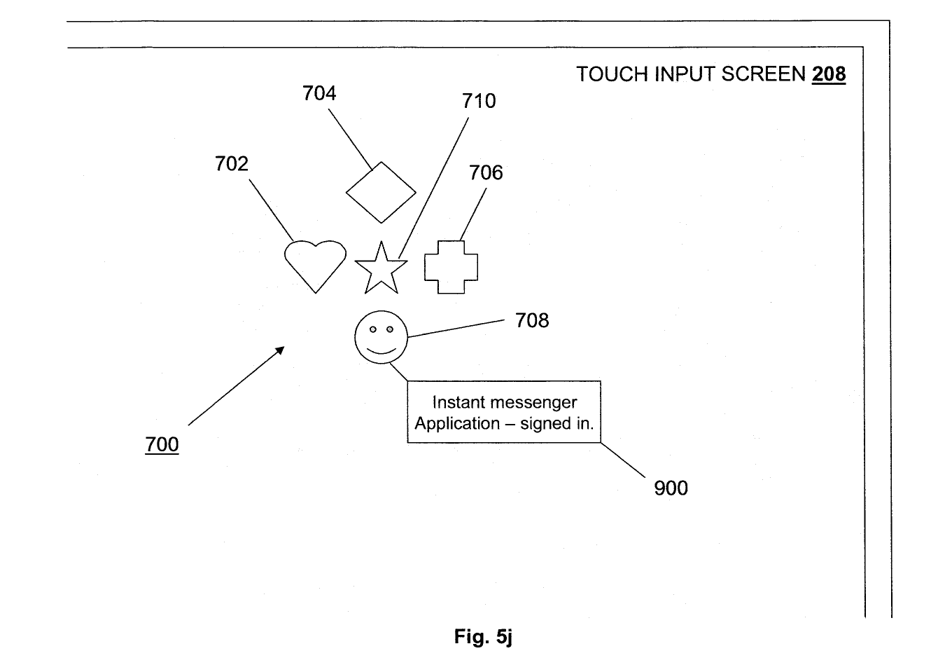

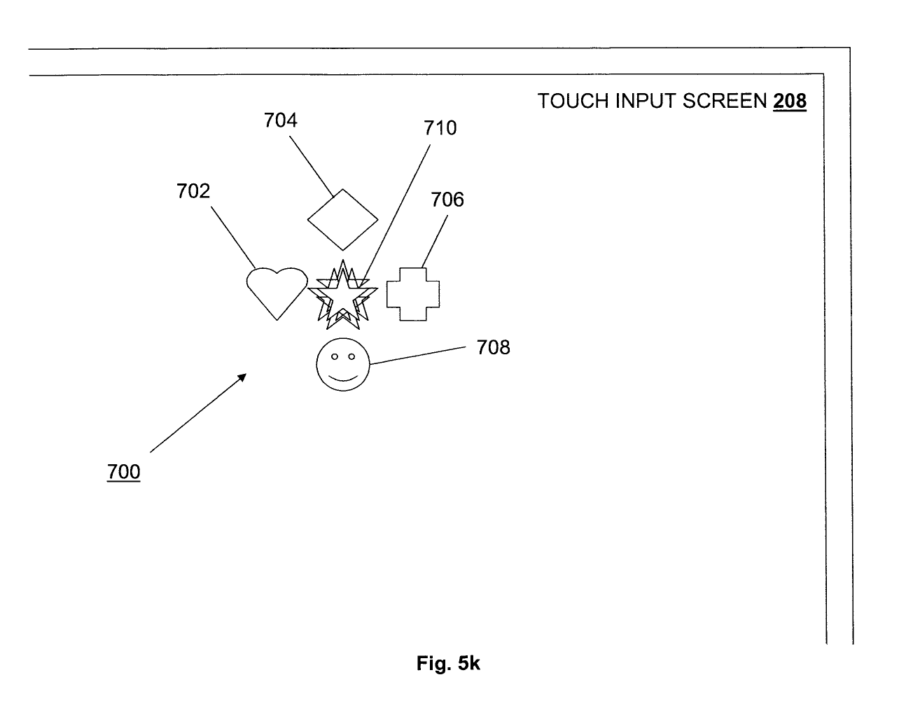

Referring now to FIG. 5a, a method 500 for providing visual feedback is illustrated. The method 500 begins at block 502 where a touch input screen is provided. The method 500 will be described generally with reference to the touch input screen 208 of the visual feedback system 200, illustrated in FIG. 2, and with additional references being made to the touch input screens 306 and 406 on the displays 300 and 400, respectively, illustrated in FIGS. 3a, 3b, 4a and 4b. However, one of skill in the art will recognize that the teachings described are applicable to a variety of touch input devices other than those illustrated such as, for example, portable/notebook computers, phones, televisions, and/or a variety of other devices known in the art that utilize touch inputs. The method 500 then proceeds to block 504 where the position of an input member is determined.

Referring now to FIG. 5b, in one embodiment, the display 300 having the touch input screen 306 is used and the input member is a finger 504a of a user. Data may be displayed on the touch input screen 306 (described in further detail below) and the finger 504a may be used to provide a touch input at a position on the touch input screen 306 that corresponds to the position that the data is displayed on the touch input screen 306. As the finger 504a is brought proximate the touch input screen 306, the proximity sensing device 308 determines the position of finger 504a relative to the touch input screen 306 prior to contact of the finger 504a with the front surface 306a of the touch input screen 306. In the illustrated embodiment, the determining of the position of the finger 504a is performed by the proximity sensing device 308 through the touch input screen 306a.

Referring now to FIG. 5c, in another embodiment, the display 400 having the touch input screen 406 is used and the input member is again the finger 504a of the user. Data may be displayed on the touch input screen 406 (described in further detail below) and the finger 504a may be used to provide a touch input at a position on the touch input screen 406 that corresponds to the position that the data is displayed on the touch input screen 406. As the finger 504a is brought proximate the touch input screen 406, the proximity sensing device 408 determines the position of finger 504a relative to the touch input screen 406 prior to contact of the finger 504a with the front surface 406a of the touch input screen 406. In the illustrated embodiment, the determining of the position of the finger 504a is performed by the proximity sensing device 408 adjacent the touch input screen 306a by, for example, utilizing infrared detection methods and using the ‘line of sight’ available between the proximity sensing device 408 and a volume that extends from an area located immediately adjacent the front surface 406a of the touch input screen 406 and away from the touch input screen 406. While the input member has been described and illustrated as a finger 504a of a user in the examples above, one of skill in the art will recognize a variety of other input members (e.g., a stylus, other user body parts, a beam of light, etc.) that fall within the scope of the present disclosure.

Referring now to FIG. 5a, the method 500 then proceeds to block 506 where visual feed back is provided. Upon the proximity sensing device 202 determining the position of the input member relative to the touch input screen 208, that position is sent to the visual feedback engine 204. In an embodiment, the visual feedback engine 204 may access the visual feedback storage 206 to determine a type of visual feedback action that is associated with the data being displayed (described in further detail below) on the touch input screen 208 and corresponding to the position of the input member relative to the touch input screen 208. The visual feedback engine 204 then provides a visual feedback for the data displayed on the touch input screen 208 and corresponding to the position of the input member relative to the touch input screen 208. Below are several examples of visual feedback that may be provided by the visual feedback engine 204 for data displayed on the touch input screen 208 upon the proximity sensing device 202 determining the position of the input member relative to the touch input screen 208 that corresponds to that data. However, one of skill in the art will recognize a variety of other visual feedbacks that fall within the scope of the present disclosure.

Referring now to FIGS. 5d and 5e, an embodiment of a visual feedback is illustrated. As described above, data may be displayed on the touch input screen 208 and the input member may be used to provide a touch input at a position on the touch input screen 208 that corresponds to the position that the data is displayed on the touch input screen 208. In the illustrated embodiment, the data includes an application window 600 having a minimize button 602, a maximize button 604, and a close button 606, as illustrated in FIG. 5d. As the input member is brought proximate the touch input screen 208, the proximity sensing device 202 determines the position of input member relative to the touch input screen 208 prior to contact of the input member with the touch input screen 208. In an embodiment, the position of the input member relative to the touch input screen 208 may include a vertical component that corresponds to a vertical location on the touch input screen 208 and a horizontal component that corresponds to a horizontal location on the touch input screen 208. In the illustrated embodiment, the position of the input member relative to the touch input screen 208, which is determined by the proximity sensing device 202 prior to the contact of the input member and the touch input screen 208, corresponds to the location of the maximize button 604 displayed on the touch input screen 208. In an embodiment, the visual feedback engine 204 accesses the visual feedback storage 206 and determines that the visual feedback action associated with the maximize button 604 is an ‘enlarge’ visual feedback action. The visual feedback engine 204 then provides visual feedback by enlarging the maximize button 604 from the size shown in FIG. 5d to the size shown in FIG. 5e, indicating that if the input member, which is not in contact with the touch input screen 208, is held at the current vertical and horizontal coordinates relative to the touch input screen 208 and then moved into contact with the touch input screen 208, the touch input provided will select the maximize button 604. Furthermore, as the input member is moved from the position corresponding to the location of the maximize button 602 displayed on the touch input screen 208 to a position corresponding to the location of, for example, the minimize button 602, the visual feedback engine 204 is operable to return the maximize button 604 to the size shown in FIG. 5d and then enlarge the minimize button 602 from the size shown in FIG. 5d to a size similar to the size of the maximize button 604 shown in FIG. 5e.

Referring now to FIGS. 5f and 5g, an embodiment of a visual feedback is illustrated. As described above, data may be displayed on the touch input screen 208 and the input member may be used to provide a touch input at a position on the touch input screen 208 that corresponds to the position that the data is displayed on the touch input screen 208. In the illustrated embodiment, the data includes a plurality of icons 700 that are located adjacent each other and that include icons 702, 704, 706, 708 and 710, as illustrated in FIG. 5f. As the input member is brought proximate the touch input screen 208, the proximity sensing device 202 determines the position of input member relative to the touch input screen 208 prior to contact of the input member with the touch input screen 208. In an embodiment, the position of the input member relative to the touch input screen 208 may include a vertical component that corresponds to a vertical location on the touch input screen 208 and a horizontal component that corresponds to a horizontal location on the touch input screen 208. In the illustrated embodiment, the position of the input member relative to the touch input screen 208, which is determined by the proximity sensing device 202 prior to the contact of the input member and the touch input screen 208, corresponds to the location of the icon 710 displayed on the touch input screen 208. In an embodiment, the visual feedback engine 204 accesses the visual feedback storage 206 and determines that the visual feedback action associated with the icon 710 is a ‘color change’ visual feedback action. The visual feedback engine 204 then provides visual feedback by changing the color of the icon 710 (e.g., relative to the icons 702, 704, 706 and 708) from the color shown in FIG. 5f to the color shown in FIG. 5g, indicating that if the input member, which is not in contact with the touch input screen 208, is held at the current vertical and horizontal coordinates relative to the touch input screen 208 and then moved into contact with the touch input screen 208, the touch input provided will select the icon 710. While the color change illustrated in FIGS. 5f and 5g is an example of making an icon brighter in color than adjacent icons, one of skill in the art will recognize a variety of different color changes that will fall within the scope of the present disclosure. Furthermore, as the input member is moved from the position corresponding to the location of the icon 710 displayed on the touch input screen 208 to a position corresponding to the location of, for example, the icon 702, the visual feedback engine 204 is operable to return the icon 710 to the color shown in FIG. 5f and then change the color of the icon 702 from the color shown in FIG. 5f to a color similar to the color of the icon 710 shown in FIG. 5g.

Referring now to FIGS. 5h and 5i, an embodiment of a visual feedback is illustrated. As described above, data may be displayed on the touch input screen 208 and the input member may be used to provide a touch input at a position on the touch input screen 208 that corresponds to the position that the data is displayed on the touch input screen 208. In the illustrated embodiment, the data includes an application window 800 having a plurality of text links 802, 804, 806, 808 and 810, as illustrated in FIG. 5h. As the input member is brought proximate the touch input screen 208, the proximity sensing device 202 determines the position of input member relative to the touch input screen 208 prior to contact of the input member with the touch input screen 208. In an embodiment, the position of the input member relative to the touch input screen 208 may include a vertical component that corresponds to a vertical location on the touch input screen 208 and a horizontal component that corresponds to a horizontal location on the touch input screen 208. In the illustrated embodiment, the position of the input member relative to the touch input screen 208, which is determined by the proximity sensing device 202 prior to the contact of the input member and the touch input screen 208, corresponds to the location of the text link 806 displayed on the touch input screen 208. In an embodiment, the visual feedback engine 204 accesses the visual feedback storage 206 and determines that the visual feedback action associated with the text link 806 is a ‘frame’ visual feedback action. The visual feedback engine 204 then provides visual feedback by framing the text link 806, as illustrated in FIG. 5i, indicating that if the input member, which is not in contact with the touch input screen 208, is held at the current vertical and horizontal coordinates relative to the touch input screen 208 and then moved into contact with the touch input screen 208, the touch input provided will select the text link 806. Furthermore, as the input member is moved from the position corresponding to the location of the text link 806 displayed on the touch input screen 208 to a position corresponding to the location of, for example, the text link 804, the visual feedback engine 204 is operable to remove the frame from the text link 806 and then frame the text link 804 with a frame that is similar to the frame provided for the text link 806 and illustrated in FIG. 5i.

Referring now to FIGS. 5f and 5j, an embodiment of a visual feedback is illustrated. As described above, data may be displayed on the touch input screen 208 and the input member may be used to provide a touch input at a position on the touch input screen 208 that corresponds to the position that the data is displayed on the touch input screen 208. In the illustrated embodiment, the data includes the plurality of icons 700 that are located adjacent each other and that include icons 702, 704, 706, 708 and 710, as illustrated in FIG. 5f. As the input member is brought proximate the touch input screen 208, the proximity sensing device 202 determines the position of input member relative to the touch input screen 208 prior to contact of the input member with the touch input screen 208. In an embodiment, the position of the input member relative to the touch input screen 208 may include a vertical component that corresponds to a vertical location on the touch input screen 208 and a horizontal component that corresponds to a horizontal location on the touch input screen 208. In the illustrated embodiment, the position of the input member relative to the touch input screen 208, which is determined by the proximity sensing device 202 prior to the contact of the input member and the touch input screen 208, corresponds to the location of the icon 708 displayed on the touch input screen 208. In an embodiment, the visual feedback engine 204 accesses the visual feedback storage 206 and determines that the visual feedback action associated with the icon 708 is a ‘hover’ visual feedback action. The visual feedback engine 204 then provides visual feedback by providing an information indicator 900 adjacent the icon 708 that includes information on the icon 708 (also known as a ‘hover’ capability) that corresponds to the position of the input member relative to the touch input screen 208, indicating that if the input member, which is not in contact with the touch input screen 208, is held at the current vertical and horizontal coordinates relative to the touch input screen 208 and then moved into contact with the touch input screen 208, the touch input provided will select the icon 708. Furthermore, as the input member is moved from the position corresponding to the location of the icon 708 displayed on the touch input screen 208 to a position corresponding to the location of, for example, the icon 710, the visual feedback engine 204 is operable to remove the information indicator 900 corresponding to the icon 708, illustrated in FIG. 5j, and then provide an information indicator for the icon 710 that is similar to the information indicator 900 provided for the icon 708 and illustrated in FIG. 5j.

Referring now to FIGS. 5f and 5k, an embodiment of a visual feedback is illustrated. As described above, data may be displayed on the touch input screen 208 and the input member may be used to provide a touch input at a position on the touch input screen 208 that corresponds to the position that the data is displayed on the touch input screen 208. In the illustrated embodiment, the data includes the plurality of icons 700 that are located adjacent each other and that include icons 702, 704, 706, 708 and 710, as illustrated in FIG. 5f. As the input member is brought proximate the touch input screen 208, the proximity sensing device 202 determines the position of input member relative to the touch input screen 208 prior to contact of the input member with the touch input screen 208. In an embodiment, the position of the input member relative to the touch input screen 208 may include a vertical component that corresponds to a vertical location on the touch input screen 208 and a horizontal component that corresponds to a horizontal location on the touch input screen 208. In the illustrated embodiment, the position of the input member relative to the touch input screen 208, which is determined by the proximity sensing device 202 prior to the contact of the input member and the touch input screen 208, corresponds to the location of the icon 710 displayed on the touch input screen 208. In an embodiment, the visual feedback engine 204 accesses the visual feedback storage 206 and determines that the visual feedback action associated with the icon 710 is a ‘vibrate’ visual feedback action. The visual feedback engine 204 then provides visual feedback by simulating movement of the icon 710, using methods known in the art, that corresponds to the position of the input member relative to the touch input screen 208, indicating that if the input member, which is not in contact with the touch input screen 208, is held at the current vertical and horizontal coordinates relative to the touch input screen 208 and then moved into contact with the touch input screen 208, the touch input provided will select the icon 710. Furthermore, as the input member is moved from the position corresponding to the location of the icon 710 displayed on the touch input screen 208 to a position corresponding to the location of, for example, the icon 702, the visual feedback engine 204 is operable to cease the simulation of movement of the icon 710, illustrated in FIG. 5k, and then simulate the movement of the icon 702 in a manner similar to the simulated movement of the icon 710 that is illustrated in FIG. 5k.

In an embodiment, the proximity sensing devices 202, 308, and/or 408 are operable to detect a user/input member at a distance that is much greater than that illustrated for the input member 504a in FIGS. 5b and 5c. For example, the proximity sensing device 202, 308, and/or 408 may be able to detect a user/input member many feet away from the visual feedback system 200 or displays 300 and 400. However, in an embodiment, the proximity sensing devices 202, 308, and/or 408 may not be able to determine the exact location of the user/input member at such distances. However, the proximity sensing devices 202, 308, and/or 408 may be able to detect a user/input member presence and, as the user/input member approaches the visual feedback system 200 or displays 300 and 400, the proximity sensing devices 202, 308, and/or 408 may be able to determine increasingly accurate location information for the user//input member and use that location information to continually refine the visual feedback provided. For example, at about a foot away, the proximity sensing device may simply be able to determine that the user/input member is present and the visual feedback provided (if any) may include the entire display screen. As the user/input member approaches to within about 6 inches, the location of the user/input member may be used to refine the visual feedback provided to within a few square inches on the display screen. The area in which the visual feedback is provided may be narrowed down further as the user/input member is positioned closer and closer to the display screen until there is contact between the user/input member and the display screen.

While the examples above describe one input member providing a touch input, the disclosure is not so limited. One of skill in the art will recognize that the teachings of the present disclosure may be applied to determine the positions of a plurality of input members relative to the touch input screen when the plurality of input members are proximate to the touch input screen but prior to the contact of the plurality of input members and the touch input screen, and that visual feedback may be provided for data on the touch input screen that corresponds to the positions of those input members. In such situations, visual feedback may be provided for multiple input member touch inputs such as, for example, touch inputs used to perform a rotate gesture, a pinch gesture, a reverse pinch gesture, and/or a variety of other multiple input member touch inputs known in the art. Furthermore, the present disclosure envisions the varying of touch inputs as a function of touch input screen form factor (e.g., small screens vs. large screens) and orientation (e.g., IHS desktop modes vs. IHS tablet modes). Thus, a system and method have been described that provide a user of a touch input device with visual feedback prior to the contact of an input member and a touch input screen in order to indicate to the user which data displayed on the touch input screen will be selected by the input member if it is brought into contact with the touch input screen, preventing the user from selecting the wrong data and decreasing the time necessary to navigate through data on a touch input device to provide a better user experience relative to convention touch input devices.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A visual feedback system, comprising:
a touch input screen;
a proximity sensing device that is coupled to the touch input screen, the proximity sensing device operable to determine a position of an input member relative to the touch input screen when the input member is proximate to the touch input screen but prior to the contact of the input member and the touch input screen; and
a visual feedback engine that is coupled to the touch input screen and the proximity sensing device, the visual feedback engine operable to receive the position of the input member from the proximity sensing device and provide a visual feedback for data displayed on the touch input screen that corresponds to the position of the input member relative to the touch input screen.

2. The system of claim 1, further comprising:
a display chassis, wherein the touch input screen is mounted to the display chassis and the proximity sensing device is housed within the display chassis and located adjacent the touch input screen such that the determining the position of the input member relative to the touch input screen is performed through the touch input screen.

3. The system of claim 1, further comprising:
a display chassis, wherein the touch input screen is mounted to the display chassis and the proximity sensing device is located on a surface of the display chassis such that the determining the position of the input member relative to the touch input screen is performed adjacent the touch input screen.

4. The system of claim 1, further comprising:
a visual feedback storage coupled to the visual feedback engine, wherein the visual feedback storage comprises at least one visual feedback action corresponding to data which the touch input screen is operable to display.

5. The system of claim 1, wherein the proximity sensing device is operable to determine the positions of a plurality of input members relative to the touch input screen when the plurality of input members are proximate to the touch input screen but prior to the contact of the plurality of input members and the touch input screen.

6. The system of claim 1, wherein the visual feedback comprises enlarging the data that is displayed on the touch input screen and that corresponds to the position of the input member relative to the touch input screen.

7. The system of claim 1, wherein the visual feedback comprises changing a color of the data that is displayed on the touch input screen and that corresponds to the position of the input member relative to the touch input screen.

8. The system of claim 1, wherein the visual feedback comprises framing the data that is displayed on the touch input screen and that corresponds to the position of the input member relative to the touch input screen.

9. The system of claim 1, wherein the visual feedback comprises providing an information indicator for the data that is displayed on the touch input screen and that corresponds to the position of the input member relative to the touch input screen.

10. An information handling system, comprising:
a processor;
a storage coupled to the processor;
a display coupled to the processor and comprising a touch input screen;
a proximity sensing device that is coupled to the touch input screen, the proximity sensing device operable to determine a position of an input member relative to the touch input screen when the input member is proximate to the touch input screen but prior to the contact of the input member and the touch input screen; and
a visual feedback engine that is coupled to the touch input screen and the proximity sensing device, the visual feedback engine operable to receive the position of the input member from the proximity sensing device and provide a visual feedback for data displayed on the touch input screen that corresponds to the position of the input member relative to the touch input screen.

11. The system of claim 10, wherein the proximity sensing device is housed in a display chassis and located adjacent the touch input screen such that the determining the position of the input member relative to the touch input screen is performed through the touch input screen.

12. The system of claim 10, wherein the proximity sensing device is located on a surface of a display chassis such that the determining the position of the input member relative to the touch input screen is performed adjacent the touch input screen.

13. The system of claim 10, wherein the visual feedback engine is coupled to the storage and the storage comprises at least one visual feedback action corresponding to data which the touch input screen is operable to display.

14. The system of claim 10, wherein the proximity sensing device is operable to determine the positions of a plurality of input members relative to the touch input screen when the plurality of input members are proximate to the touch input screen but prior to the contact of the plurality of input members and the touch input screen

15. A method for providing visual feedback, comprising:
providing a touch input screen;
determining a position of an input member relative to the touch input screen when the input member is proximate to the touch input screen but prior to the contact of the input member and the touch input screen; and
providing a visual feedback for data displayed on the touch input screen that corresponds to the position of the input member relative to the touch input screen.

16. The method of claim 15, wherein the visual feedback comprises enlarging the data that is displayed on the touch input screen and that corresponds to the position of the input member relative to the touch input screen.

17. The method of claim 15, wherein the visual feedback comprises changing a color of the data that is displayed on the touch input screen and that corresponds to the position of the input member relative to the touch input screen.

18. The method of claim 15, wherein the visual feedback comprises framing the data that is displayed on the touch input screen and that corresponds to the position of the input member relative to the touch input screen.

19. The method of claim 15, wherein the visual feedback comprises providing an information indicator for the data that is displayed on the touch input screen and that corresponds to the position of the input member relative to the touch input screen.

20. The method of claim 15, wherein the visual feedback comprises simulating movement of the data that is displayed on the touch input screen and that corresponds to the position of the input member relative to the touch input screen.
